(19) United States
(12) Patent Application Publication
(10) Pub. No.: US 2014/0025719 A1
(43) Pub. Date: Jan. 23, 2014

(54) ASYNCHRONOUS DISTRIBUTED COMPUTING BASED SYSTEM

(71) Applicant: Alexander A. Kalinkin, Novosibirsk (RU)

(72) Inventor: Alexander A. Kalinkin, Novosibirsk (RU)

(21) Appl. No.: 13/995,520

(22) PCT Filed: Jul. 2, 2012
(86) PCT No.: PCT/RU2012/000535

§ 371 Date: Oct. 7, 2013

(51) Int. Cl. G06F 17/14

(52) U.S. Cl. CPC G06F 17/14
USPC 708/401

(57) ABSTRACT

An embodiment of the invention includes asynchronous data calculation and data exchange in a distributed system. Such an embodiment is appropriate for advanced modeling projects and the like. One embodiment includes a distribution of a matrix of data across a distributed computing system. The embodiment combines transform calculations (e.g., Fourier transforms) and data transpositions of the data across the distributed computing system. The embodiment further combines decompositions and transpositions of the data across the distributed computing system. The embodiment thereby concurrently performs data calculations (e.g., transform calculations, decompositions) and data exchange (e.g., message passage interface messaging) to promote distributed computing efficiency. Other embodiments are described herein.

### BACKGROUND

Real-world problems can be difficult to model. Such problems include, for example, modeling fluid dynamics, electromagnetic flux, thermal expansion, or weather patterns. These problems can be expressed mathematically using a group of equations known as a system of simultaneous equations. Those equations can be expressed in matrix form. A computing system can then be used to manipulate and perform calculations with the matrices and solve the problem.

In some instances a distributed computing system is used to solve the problem. A distributed system consists of autonomous computing nodes that communicate through a network. The compute nodes interact with each other in order to achieve a common goal. In distributed computing, a problem (such as the aforementioned modeling problems) is divided into many tasks, each of which is solved by one or more computers. The distributed compute nodes communicate with each other by message passing.

When certain methods (e.g., a Poisson solver) are used in distributed computing, data exchange between nodes (e.g., message passing) can cause delay. More specifically, as the number of processes on different nodes increases, so too does idle processor time that occurs during data exchange between nodes.

### BRIEF DESCRIPTION OF THE DRAWINGS

Features and advantages of embodiments of the present invention will become apparent from the appended claims, the following detailed description of one or more example embodiments, and the corresponding figures, in which:

FIG. 1 includes a conventional matrix of data.

FIGS. 2-4 include methods of processing a conventional matrix of data.

FIGS. 5a-c include distribution of a matrix of data across a distributed computing system in an embodiment of the invention.

FIGS. 6a-10c include combined Fourier transforms and transpositions of a matrix of data across a distributed computing system in an embodiment of the invention.

FIGS. 11a-14c include combined decompositions and transpositions of a matrix of data across a distributed computing system in an embodiment of the invention.

FIGS. 15a-16c include Fourier transforms of a matrix of data across a distributed computing system in an embodiment of the invention.

FIGS. 17a-b include Fourier transforms of data across a distributed computing system in an embodiment of the invention.

FIG. 18 includes a system for inclusion in a distributed computing system in an embodiment of the invention.

FIG. 19 includes a distributed computer cluster in one embodiment of the invention.

### DETAILED DESCRIPTION

In the following description, numerous specific details are set forth but embodiments of the invention may be practiced without these specific details. Well-known circuits, structures and techniques have not been shown in detail to avoid obscuring an understanding of this description. “An embodiment”, “various embodiments” and the like indicate embodiment(s) so described may include particular features, structures, or characteristics, but not every embodiment necessarily includes the particular features, structures, or characteristics. Some embodiments may have some, all, or none of the features described for other embodiments. “First”, “second”, “third” and the like describe a common object and indicate different instances of like objects are being referred to. Such adjectives do not imply objects so described must be in a given sequence, either temporally, spatially, in ranking, or in any other manner. “Connected” may indicate elements are in direct physical or electrical contact with each other and “coupled” may indicate elements co-operate or interact with each other, but they may or may not be in direct physical or electrical contact. Also, while similar or same numbers may be used to designate same or similar parts in different figures, doing so does not mean all figures including similar or same numbers constitute a single or same embodiment.

An embodiment of the invention includes asynchronous data calculation and data exchange in a distributed system. Such an embodiment is appropriate for advanced modeling projects and the like. One embodiment includes a distribution of a matrix of data across a distributed computing system. The embodiment combines transform calculations (e.g., Fourier transforms) and data transpositions of the data across the distributed computing system. The embodiment further combines decompositions and transpositions of the data across the distributed computing system. The embodiment thereby concurrently performs data calculations (e.g., transform calculations, decompositions) and data exchange (e.g., message passage interface messaging) to promote distributed computing efficiency. Other embodiments are described herein.

A conventional way to solve a system of equations with a positive symmetric stiffness matrix is to use an iterative solver with a preconditioner. If this system originates from a system of differential equations, a 7-point grid Laplace operator is sometimes used as a preconditioner. To use it on each iterative step, one needs to solve a system of equations Ax=b, where A is a grid Laplace operator, x is an unknown vector, and b is residual of the current step. The main reason to use this preconditioner is to separate variables in matrix A. Matrix A can be represented as follows:

A=Dₓ [symbol] D_{y} [symbol] C_{z}+Dₓ [symbol] C_{y} [symbol] D_{z}+C_{z} [symbol] Dₓ [symbol] D_{z}

where Dₓ, D_{y}, and D_{z} are diagonal matrices (the matrices are equal to a unit matrix if one chooses a Laplace equation with the Dirichle boundary condition or to a unit matrix with a combination of ½ elements in a boundary position) with sizes Nₓ×Nₓ, N_{y}×N_{y}, and N_{z}×N_{z}, respectively, and Cₓ, C_{y}, C_{z} are tri-diagonal positive semi-defined matrices of the same sizes. So if the x and b vectors are 3-dimensional arrays, the solution of the equation Ax=b can be represented using the following pseudocode:

```
PSEUDOCODE 1
//step 1 //Fourier transformation in the Y dimension
i = 1..nx
{k = 1..nz
  Real forward Fourier transform(f(i,:,k));
}
//step 2 //Fourier transformation in the X dimension
j = 1..ny
{k = 1..nz
  Real forward Fourier transform(f(:,j,k));
}
//step 3 //LU Decomposition
i = 1..nx
{j = 1..ny
Tri-diagonal solver (f(i,j,:)); // tri-diagonal solver for matrix with size N_{z}×N_{z}
}
//step 4 //Fourier transformation in the X dimension
j = 1..ny
{k = 1..nz
  Real backward Fourier transform(f(:,j,k));
}
//step 5 //Fourier transformation in the Y dimension
i = 1..nx
{k = 1..nz
  Real backward Fourier transform(f(i,:,k));
}
```

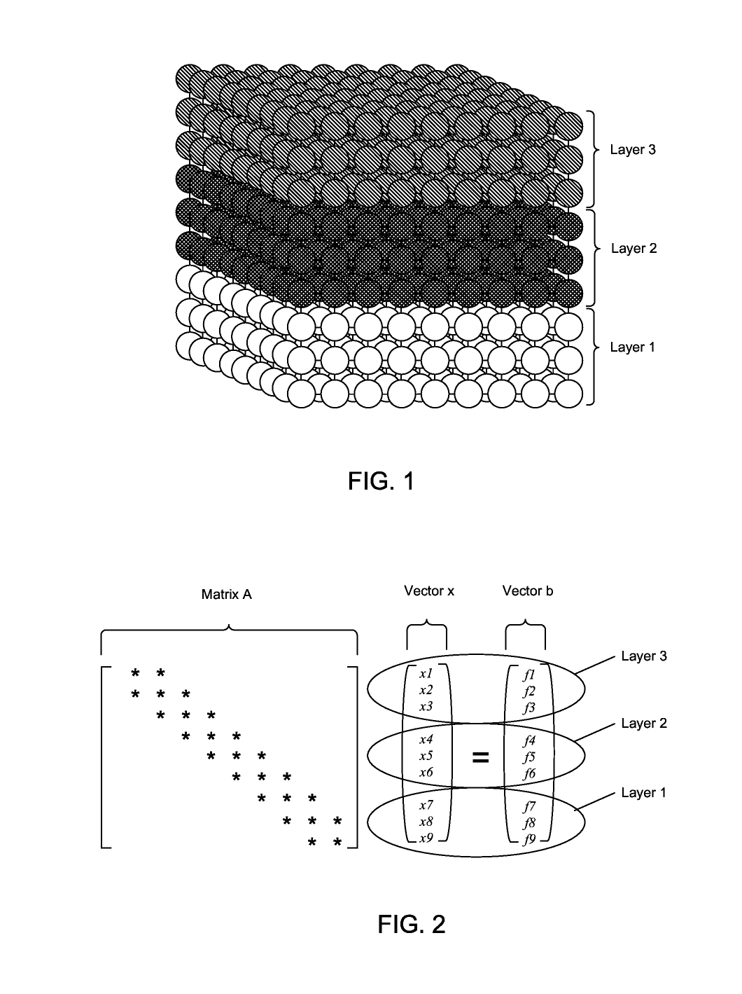

With distributed computing, the above method may be performed as follows. An initial domain is cut to form several layers (see FIG. 1) and unknowns from each layer are stored in one process on a compute node. In this decomposition of unknowns, steps 1-2 and 4-5 of the above pseudocode can be implemented independently on different processes (except the loop from 1 to Nz, which is changed to the loop from nz_first_local to nz_last_local). The implementation of step 3 on several processes is the solution of many systems with 3-diagonal matrices where the right-hand side and the solution vector are decomposed between the processes as shown in FIG. 2.

A conventional method for solving such an equation is reduction. For example, each process resolves a small 3-diagonal subsystem and then the main process calculates the additional 3-diagonal subsystem with the number of unknowns equal to the number of a particular process. Consequently, when the number of processes is relatively large, the solution time for the last subsystem can become computationally expensive. Thus, the above pseudocode is non-optimal for instances that concern a large number of processes.

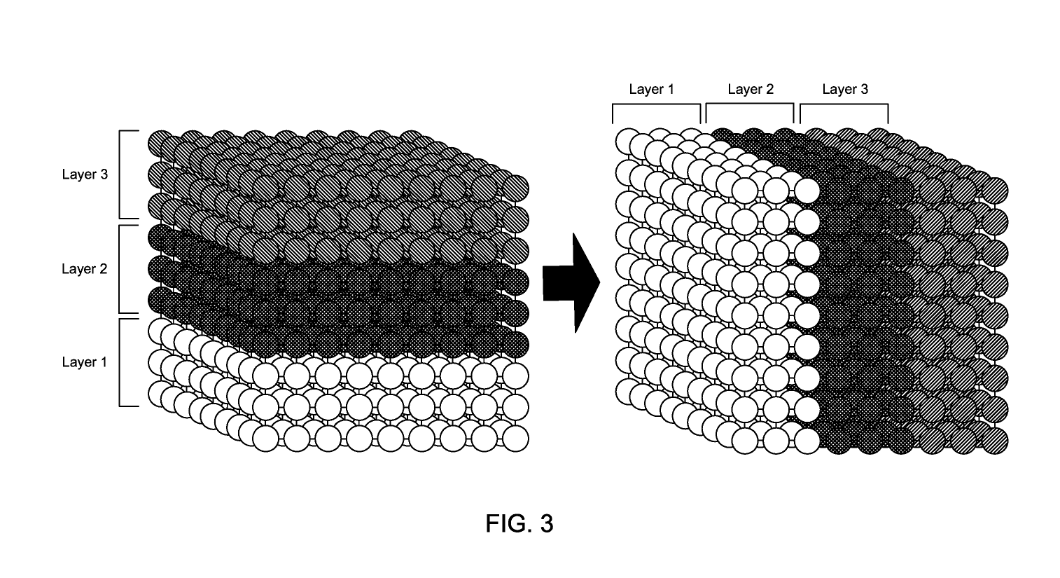

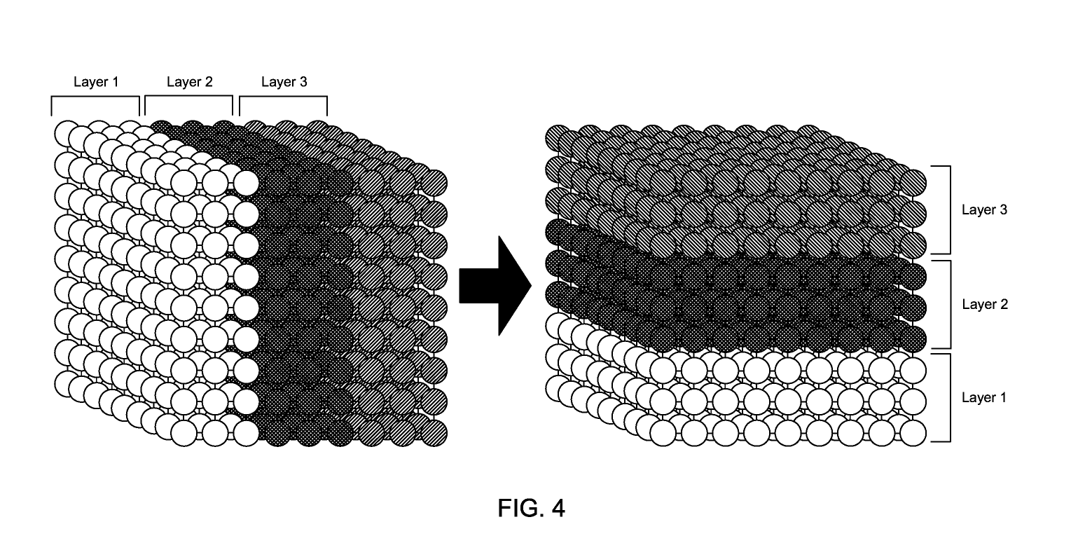

FIGS. 3 and 4 concern an additional conventional method for solving the aforementioned types of problems. FIG. 3 depicts transposing data between processes. Tri-diagonal matrices on each process are then solved without communication between the processes. FIG. 4 includes inverting the transposed data. In this approach, none of the processes computes anything during the data transposition. While this may not be overly problematic for a small number of processes, the problem is problematic when the number of processes is growing (and gets comparable with min(nx, ny, nz)). In such an instance, the time for data transposition is significant.

However, one embodiment of the invention uses an asynchronous approach to resolve the issue. Regarding Pseudocode 1, step 2 is combined with a data transposition action. Step 2 can be represented using the following scheme as described above:

PSUEDOCODE 2
j = 1..ny //Fourier transformation in the X dimension when the domain is
divided between several processes. Thus, only a small “slice” of data
is stored on each process
{k = nz_first_local.. nz_last_local
Real forward Fourier transform(f(:,j,k));
}

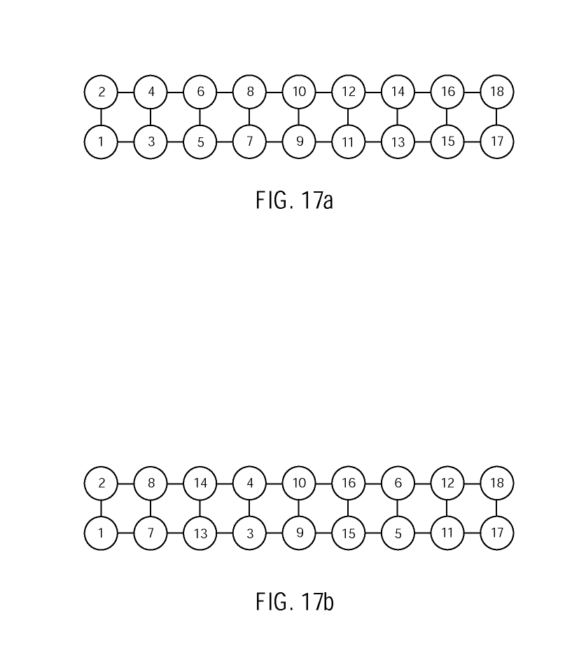

However, an embodiment changes the order of the loop. One embodiment changes the sequence of data for which the Fourier decomposition is applied. In Pseudocode 2 Fourier decomposition was applied to a vector where pair (j,k) is equal to (nz_first_local,1), which is changed to (nz_first_local+1,1), . . . , (nz_last_local,1), (nz_first_local,2) and so on. FIGS. 17a-b illustrates the data sequence change where the numbers in the circles represent serial numbers of a local vector in a sequence. With Pseudocode 3 the sequence of data in FIG. 17a is changed to that of FIG. 17b.

```
PSEUDOCODE 3
j = 1 .., ny/number_of_processes
{j_proc = 0..(number_of_processes−1)
  {j_local = j_proc*number_of_processes+j;
  k = nz_first_local.. nz_last_local
    {
    Real forward Fourier transform(f(:,j_local,k));
    }
  }
}
```

Doing so enables an embodiment to transpose the data concurrently with performance of step 2 because some data to be sent to different processes has already been computed. Thus, an embodiment performs, for example, a Fourier transform calculation with data transfer as indicated in pseudocode below.

```
PSEUDOCODE 4
$Parallel numthreads = 2
If thread is not postman
{
  j = 1 .., ny/number_of_processes
  {j_proc = 0..(number_of_processes−1)
$Parallel numthreads = max_threads−1
    {j _local = j_proc*number_of_processes+j;
    k = nz_first_local.. nz_last_local
      {
      Real forward Fourier transform(f(: j_local,k));
      }
    }
  $End parallel region
}
If thread is postman
{
  If j calculated then transpose data between processes
}
```

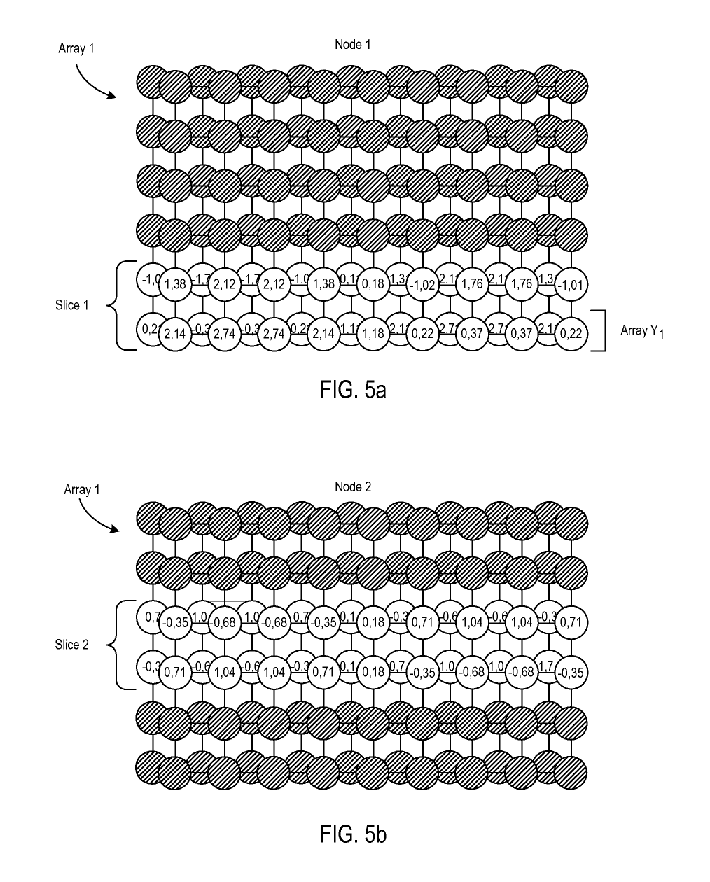

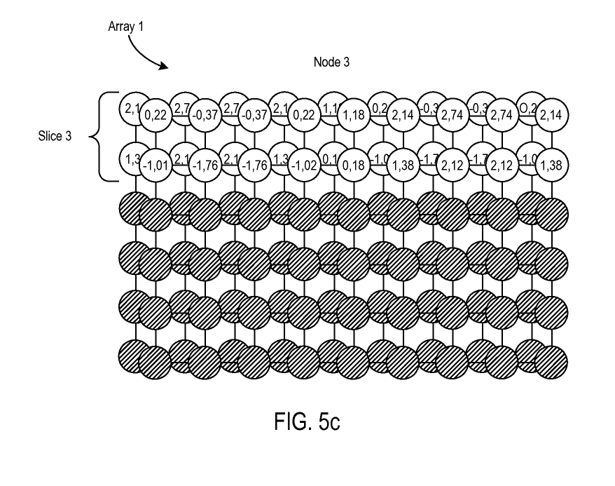

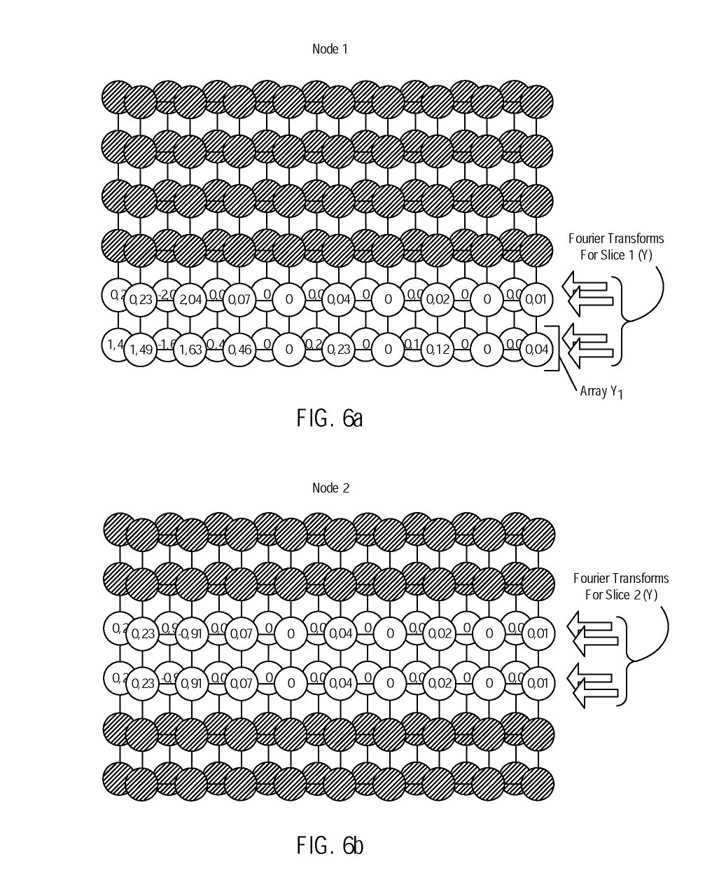

One thread of the potential threads is reserved (i.e., not used for computing Fourier transforms) to focus on data transfer between the processes. This thread is called “postman” as a reference to its data delivery role. Thus, step 2 is combined with data transposition, which improves the performance of, for example, Poisson solvers for distributed memory compute systems. Further details are provided below with reference to FIGS. 5a-16c.

FIGS. 5a-16c are discussed below and illustrate an embodiment. FIGS. 5a-c include a cube or matrix for data “array 1” of size (nx=2, ny=9, nz=6). The example addresses how the embodiment solves a discrete Helmholtz problem on such a domain for array 1. In FIGS. 5a-c initial data is distributed or assigned between three processes respectively FIGS. 5a, 5b, 5c. Process 1 (running on node 1) (FIG. 5a) contains or is assigned data from a lower “slice” (slice 1), Process 2 (running on node 2) (FIG. 5b) contains or is assigned a middle “slice” (slice 2), and Process 3 (running on node 3) (FIG. 5c) contains or is assigned the upper “slice” (slice 3). Numerical values are assigned to the elements of the matrix for the sake of explanation and indicate what data is stored in a process and node at any given moment. (This general presentation style of distributing three processes across three figures Xa, Xb, Xc is used from FIG. 5a-16c).

A conventional method may attempt to solve this Helmholtz problem using a five step algorithm with two data transposition steps between LU-decomposition (step 3) and Fourier steps 2 and 4 (see Pseudocode 1). However, embodiments of the invention combine one or more transposition steps with calculation steps. For example, FIGS. 5-16 depict combining transposition with step 2 and/or further combining transposition with step 3. However, other embodiments may combine more or fewer calculation/data exchange steps (e.g., combining transposition with step 2 or combining transposition with step 3).

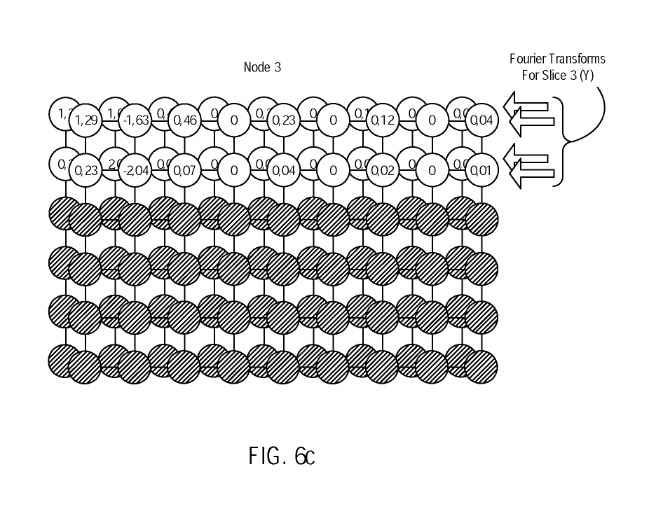

In FIGS. 6a-c a Fourier transform (i.e., also referred to herein as “decomposition”) is conducted on each of nodes 1-3 for their respective slices. This is done in the Y dimension. This may occur in parallel across the three nodes and processes so a Fourier transform occurs concurrently for Process 1/Node 1, Process 2/Node 2, and Process 3/Node 3. Each process calculates its Fourier transform independently of the other processes. A Fourier transform may be represented as a combination of element vector V by length n to result in vector W by the same length n. In the example of FIGS. 6a-c, each process works with 4 one dimensional arrays, each of length ny (i.e., 4 rows of data). The result of each discrete Fourier transform (DFT) to each vector is stored in the same place from which the initial data was stored. In other words, array Y1 of FIG. 5a is subjected to a Fourier transform with the results stored in array Y1 of FIG. 6a. The “result vector” replaces the “initial vector”. This data replacement technique is repeated at various locations in FIGS. 5a-16c for this example. Below is an example of related pseudocode:

```
PSEUDOCODE 5
i = 1..nx
{k = nz_first..nz_last
  Real forward Fourier transform(f(i,:,k)); //input data is array of
  length ny,
// output with same length replaces initial one
}
```

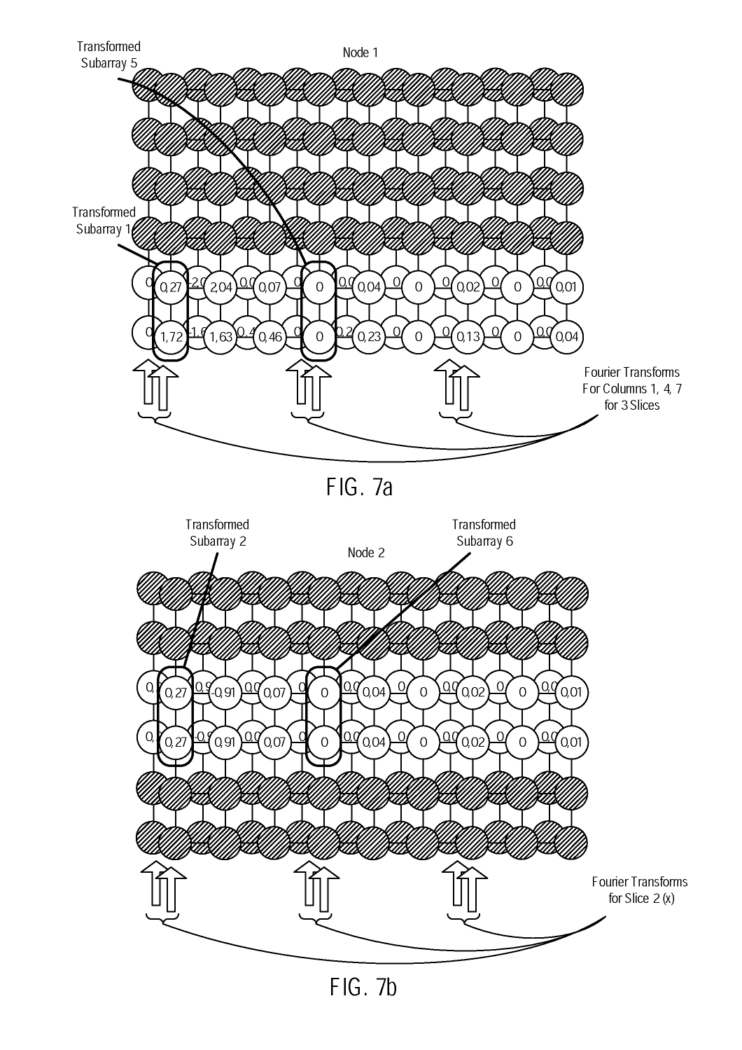

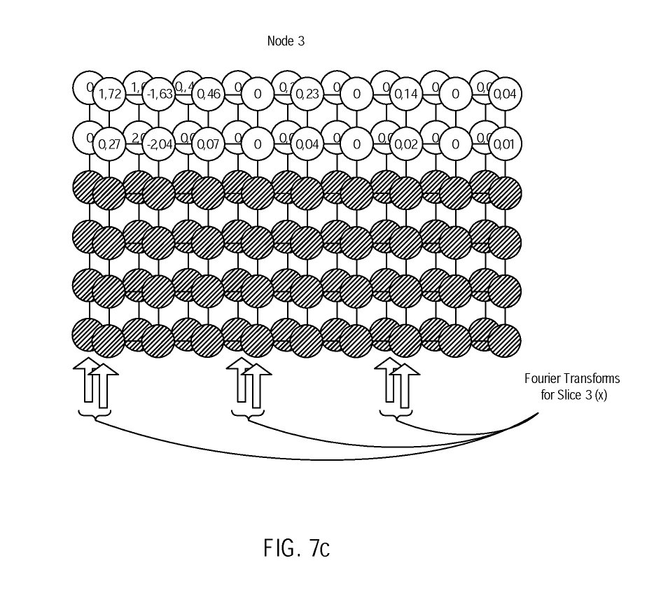

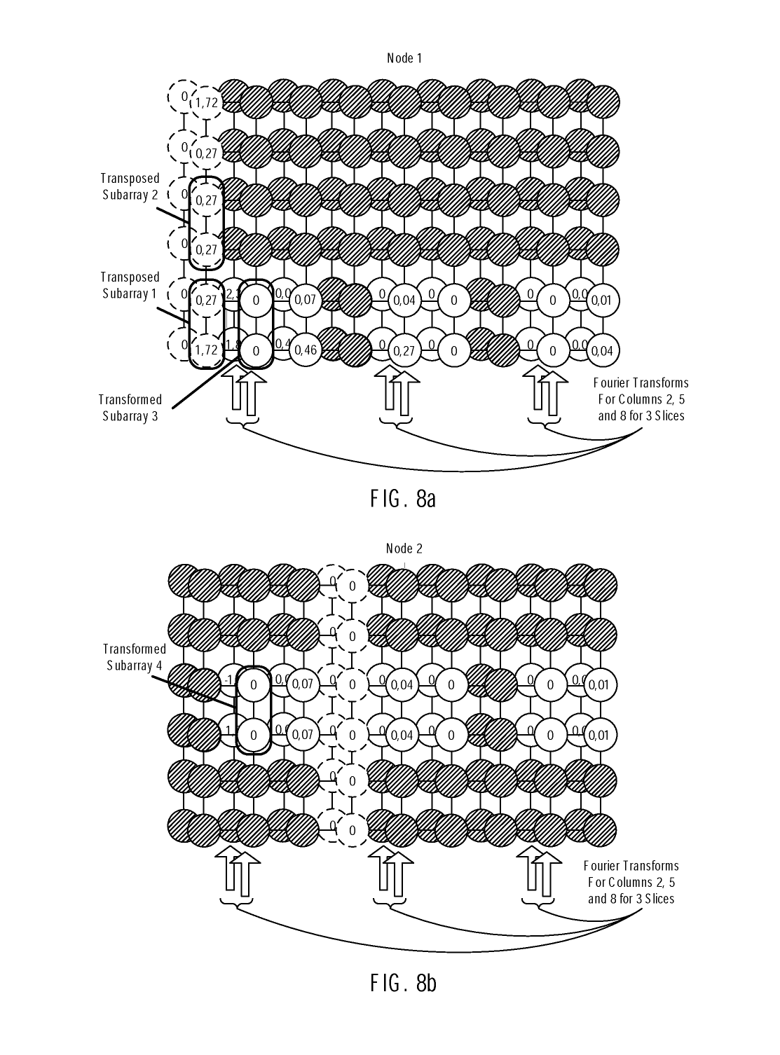

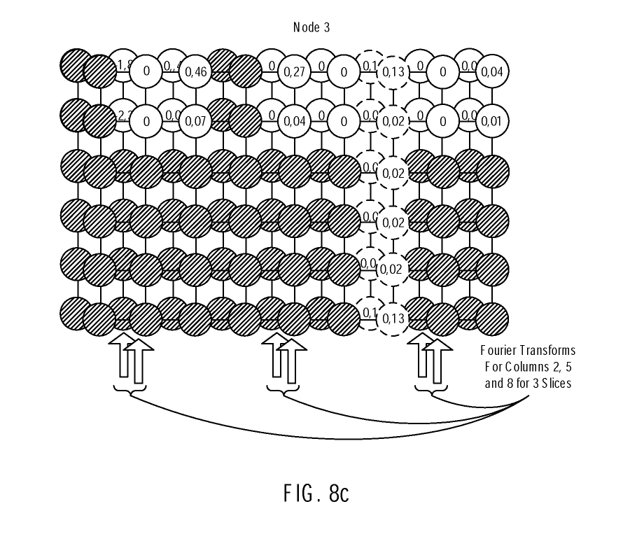

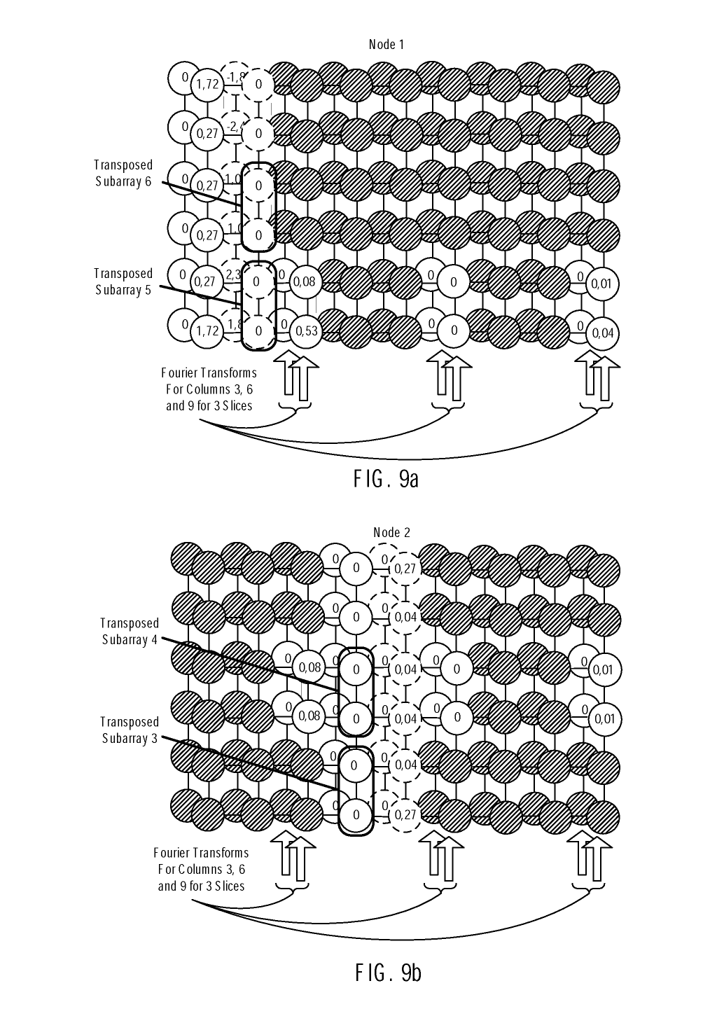

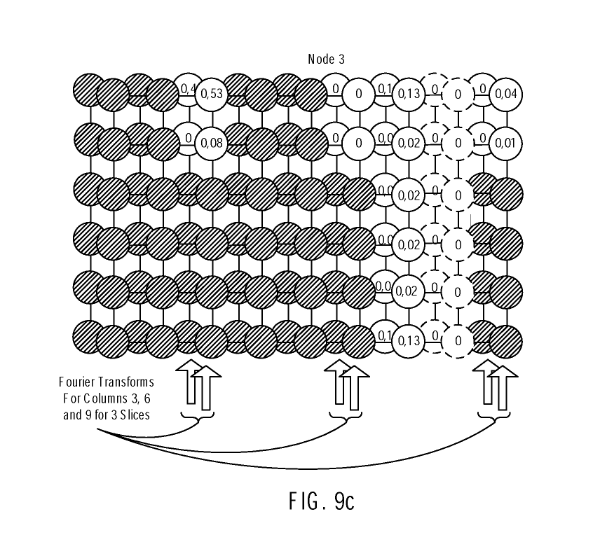

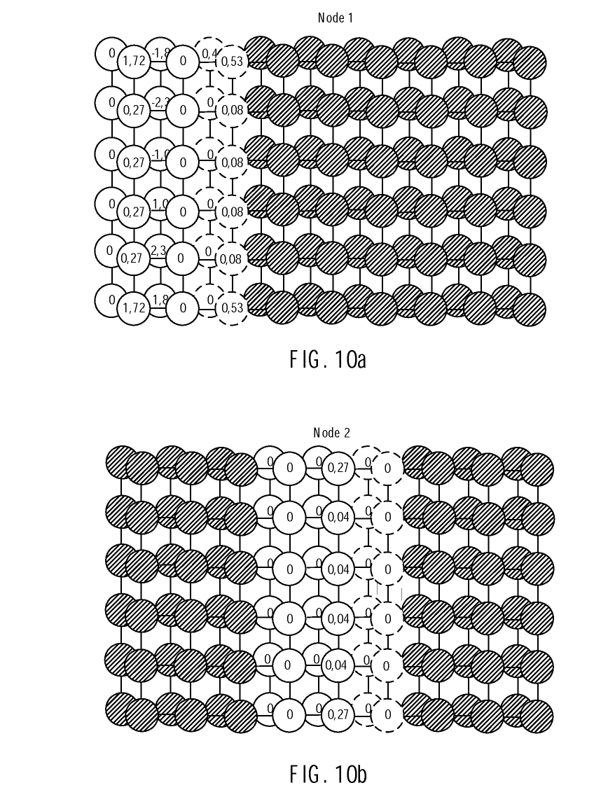

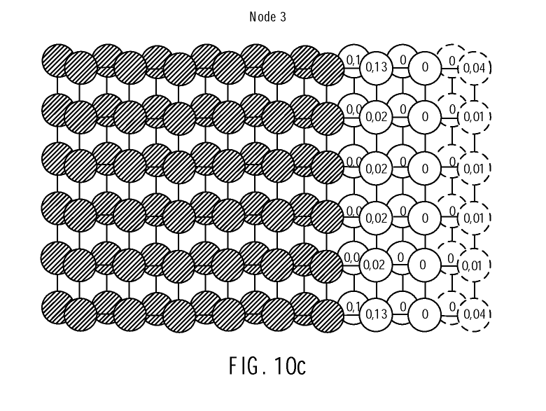

FIGS. 7a-c include a step analogous to step 2 of Pseudocode 1, which is to determine a Fourier decomposition or transform (forward) in the X dimension. To combine step 2 with a transposition action the Fourier transforms for the X dimension are calculated as shown in FIGS. 7a-c. For this particular example, the process calculates 6 Fourier transforms in the X dimension per process/node (e.g., DFT of length 2 operated on 6 arrays per process). In other words, FIGS. 7a-c show transforms conducted for columns 1, 4, and 7 for slices 1, 2, and 3. FIGS. 8a-c show transforms conducted for columns 2, 5, and 8 for slices 1, 2, and 3. FIGS. 9a-c illustrate the transform procedures (shown in FIGS. 7a-c for all three slices of columns 1, 4, and 7 and shown in FIG. 8a-c for all three slices of columns 2, 6, and 8) for all three slices of columns 3, 5, and 9. FIGS. 10a-c show the end result of the transforms performed across all three slices for columns 1-9. Different threads of a node may be used to conduct concurrent Fourier calculations not just on, for example, columns 1, 4 and 7 but also for columns 1 and 2, and the like.

After one transform has occurred for one or more slices (e.g., see FIGS. 7a-c for the transform of columns 1, 4, and 7), one thread from one or more processes can be reserved or dedicated to data transfer. Such a thread, as indicted above, may be called “postman” to indicate its role in delivery of information. In an embodiment, the postman thread (e.g., one for each of process 1 on node 1, process 2 on node 2, and process 3 on node 3) works only on transfer of data between processes. Such a transfer may occur via, for example, a message passing interface (MPI) routine (e.g., MPI_alltoallv).

Thus, an embodiment can implement the postman threads while transforms are still being calculated (e.g., data being calculated in FIGS. 8a-c for columns 2, 5, 8 on each node) because certain data needed for transfer (e.g., data already transformed in FIGS. 7a-c for columns 1, 4, 7 of each node) is already calculated and may be transferred. Returning to FIGS. 8a-c, the transfer for processes 1, 2, and 3 has occurred and populated the first column of process 1 (node 1) with transposed data from column 1 of each of processes 1, 2, and 3 (i.e., slices 1, 2, and 3). In other words, in FIGS. 8a-c several examples of transposed data are indicated such as “transposed subarray 1” which corresponds to “transformed subarray 1” of FIG. 7a, and “transposed subarray 2” which corresponds to “transformed subarray 2” of FIG. 7b. Not all transposed data is labeled for purposes of clarity. Thus, the transposition of “transposed subarray 1” and “transposed subarray 2” in FIG. 8a occurs concurrently with the Fourier transform of columns 2, 5, and 8 for the three nodes.

FIGS. 9a-c show several additional examples of transposed data such as “transposed subarray 3” which corresponds to “transformed subarray 3” of FIG. 8a, and “transposed subarray 4” which corresponds to “transformed subarray 4” of FIG. 8b. FIGS. 9a-c further show examples of transposed data indicated such as “transposed subarray 5” which corresponds to “transformed subarray 5” of FIG. 7a, and “transposed subarray 6” which corresponds to “transformed subarray 6” of FIG. 7b. Pseudocode 4 (above) may be applicable to the combined transform and transpose procedures.

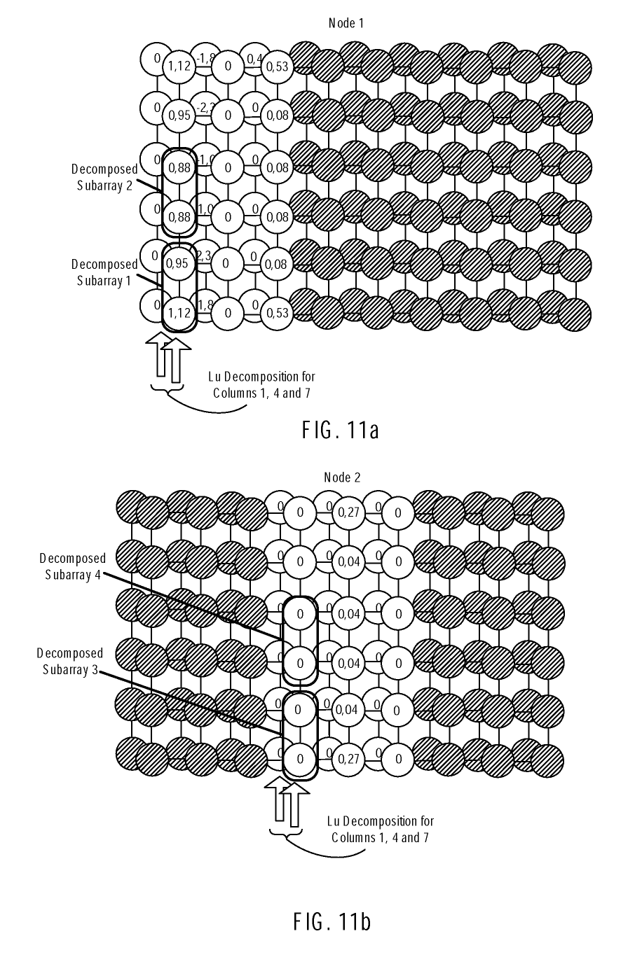

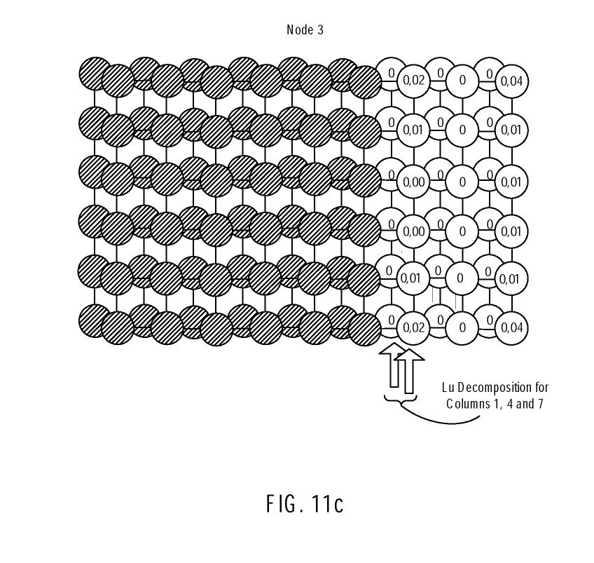

In FIGS. 11a-c a LU decomposition begins on each process independently. A LU decomposition includes a solution of some system of linear equations with a 3 diagonal matrix where the right-hand-side is the initial vector and the solution of this system is the resultant vector. In other words, LU decomposition is a routine that, from an initial vector of length n, calculates a resultant vector of length n. FIGS. 11a-c highlight a few decomposed subarrays, such as decomposed subarrays 1-4 corresponding to transposed subarrays 1-4 of previous figures. While a LU decomposition is used for illustration purposes, embodiments are not limited to LU decomposition and may include, for example, Fourier decompositions or other reduction algorithms.

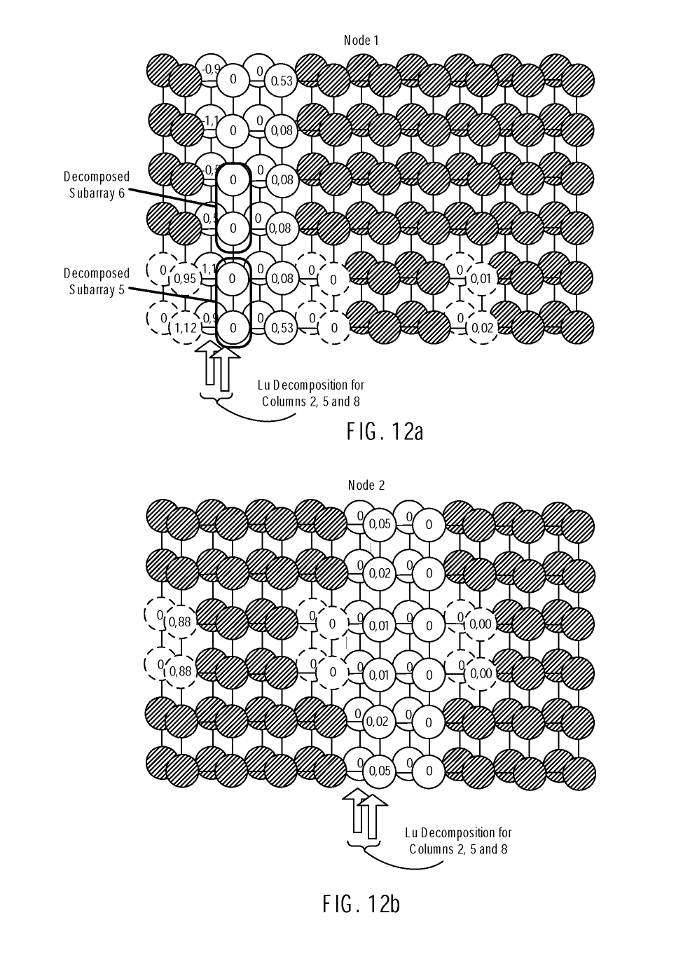

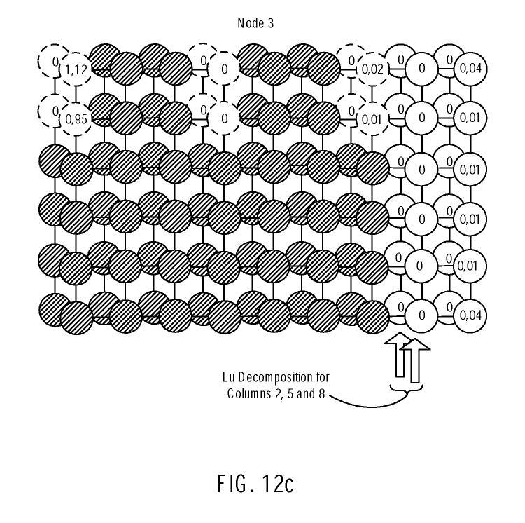

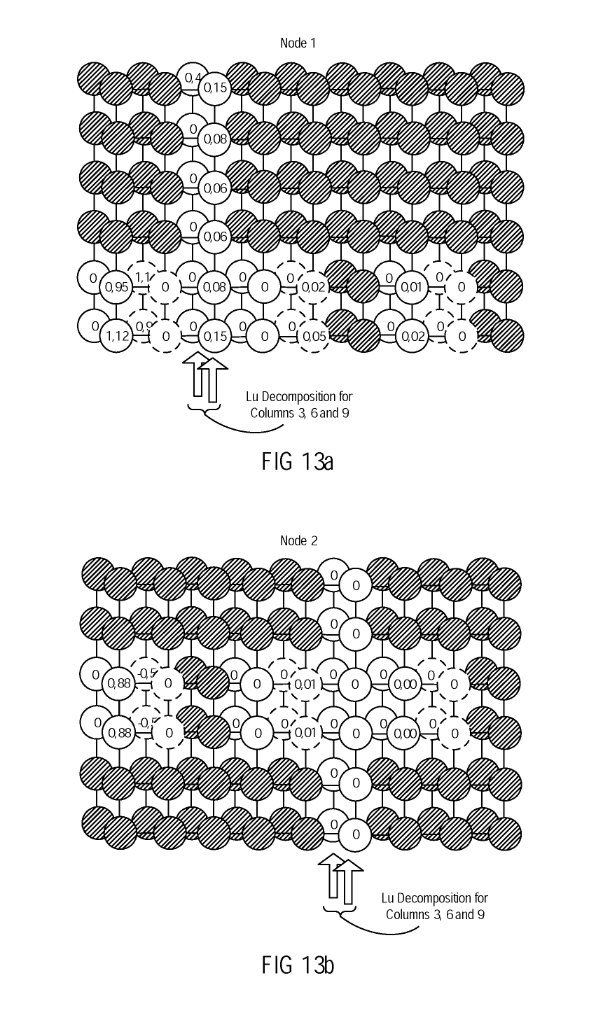

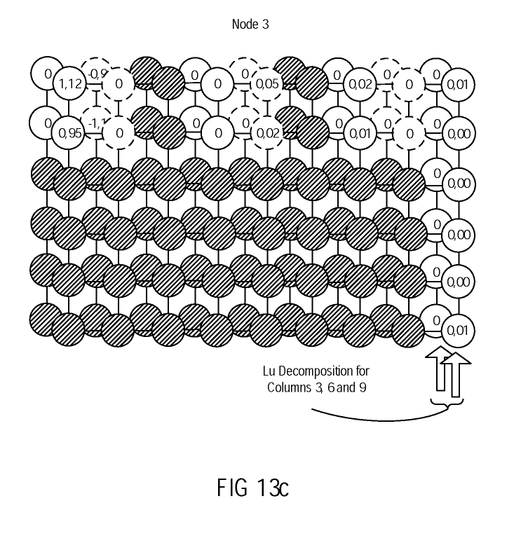

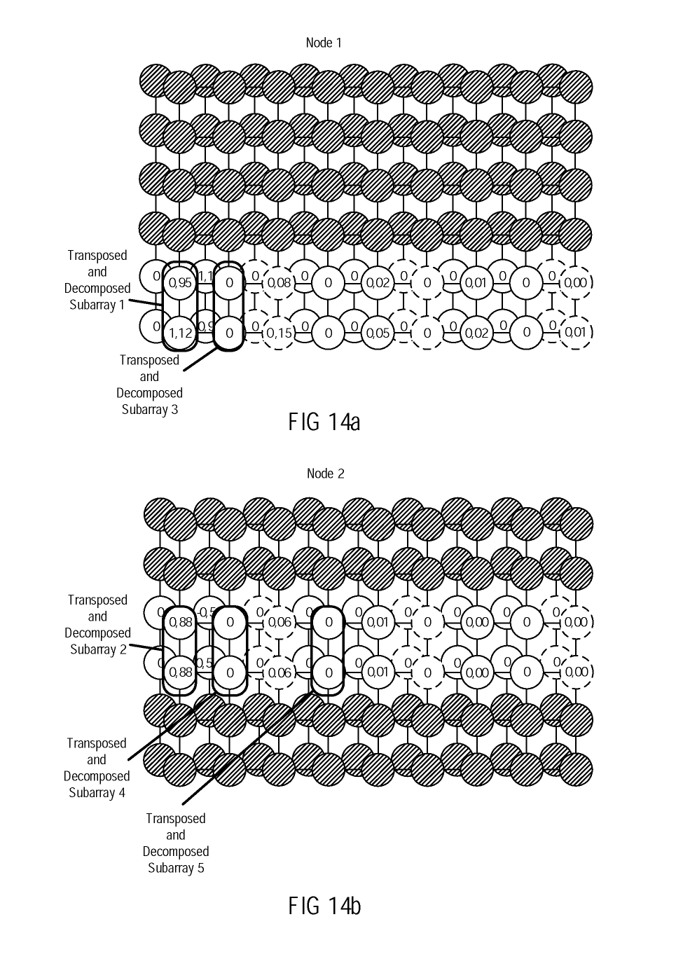

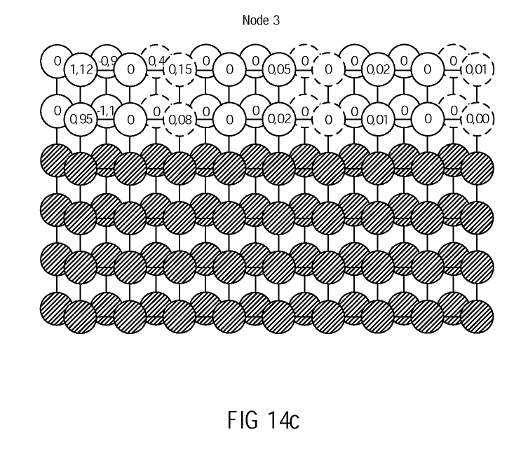

FIGS. 12a-c show the progression of decomposition from columns 1, 4, and 7 to columns 2, 5, and 8. FIGS. 13a-c show the progression of decomposition from columns 2, 5, and 8 to columns 3, 6, and 9. FIGS. 14a-c show how node 1 now includes decomposed and transposed subarrays 1 and 3, node 2 includes decomposed and transposed subarrays 2, 4, and 5. As seen in, for example, FIGS. 13a-c, transposed and decomposed subarrays (e.g., subarray 3) are transposed while decomposition of data (e.g., column 3) is concurrently being conducted. The same is true for FIGS. 12a-c regarding concurrently operations on subarrays 1 (transposed) and 3 (decomposed). Pseudocode 6 provides further explanation.

```
PSEUDOCODE 6
}
$Parallel numthreads = 2
If thread is not postman
{
  j_local = ny_first_local ..,ny_last_local; //in this example j changes from 1 to 3, which
corresponds to 3 substeps with LU decomposition
$Parallel numthreads = max_threads−1 //there could be several “computational” threads
    {i = 1, nx;
        LU decomposition(f(i,j_locaj,:)); // input data is array of length nz, output with same
length replace initial one
      }
  $End parallel region
}
If thread is postman
{
  If j_local calculated then transpose data between processes //in this example j changes
from 1 to 3, which corresponds to 3 substeps with Fourier decomposition
}
```

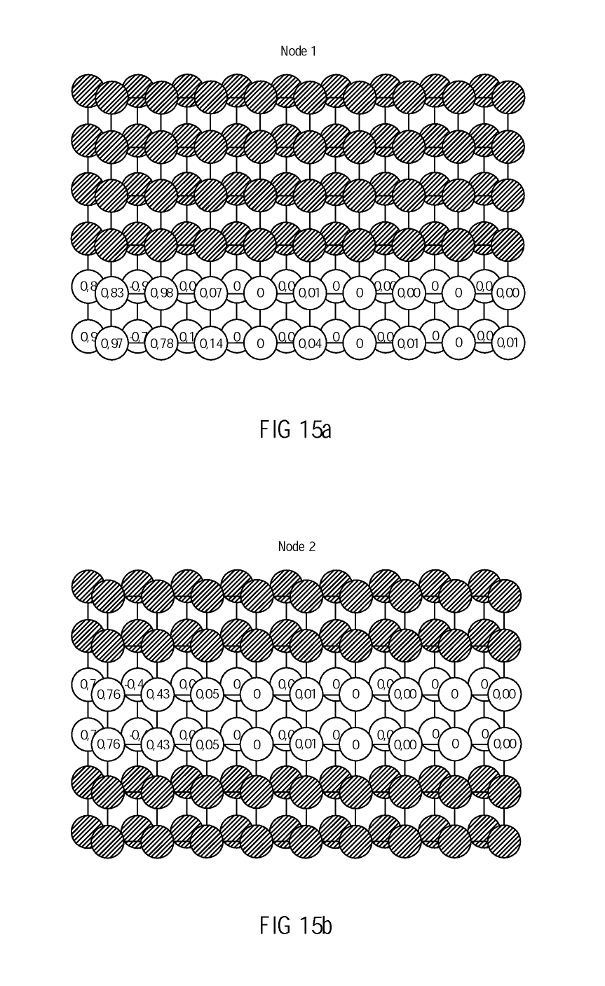

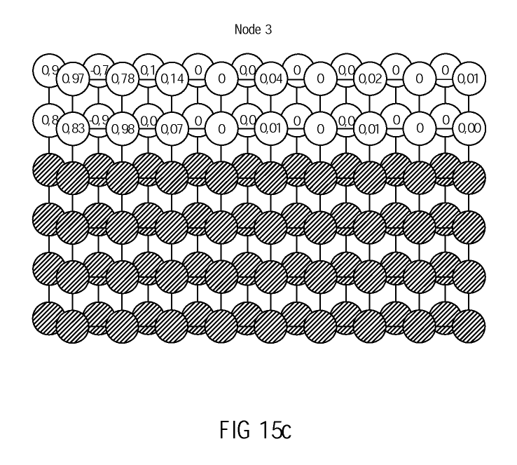

The next step is calculation of Fourier transformation (backward) in the X dimension. In an embodiment each process calculates, using multiple threads, Fourier decomposition of 18 arrays of length 2 (see FIGS. 15a-c). The distribution of elements does not change but the value of each element is changed by Fourier transformation. See Pseudocode 7 for further details.

PSEUDOCODE 7
j = 1..ny
{k = nz_first..nz_last
Real forward Fourier transform(f(:,j,k)); //input data is array of length nx, output with same
length replace initial one
}

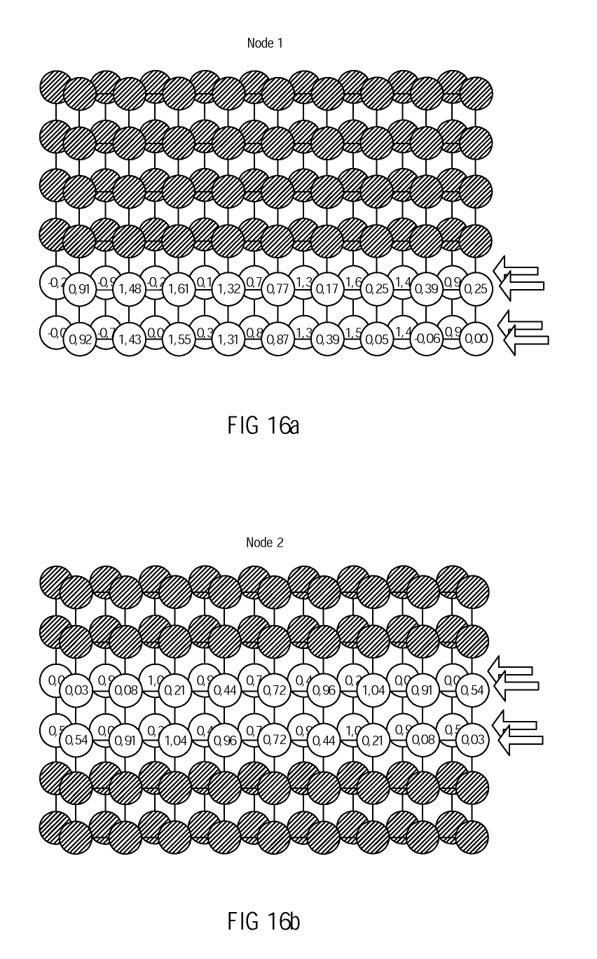

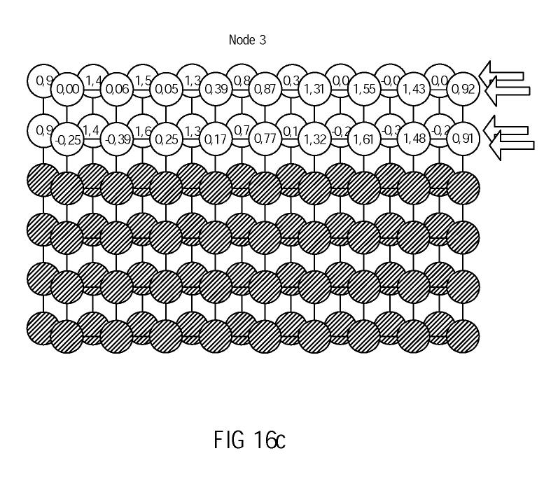

FIGS. 16a-c depict calculation of the Fourier transform (backward) in the Y dimension. Fourier decomposition of 4 arrays of length 6 is conducted. The distribution of elements does not change but the value of each element is changed by Fourier transformation. See Pseudocode 8 for further details.

PSEUDOCODE 8
i = 1..nx
{k = nz_first..nz_last
Real forward Fourier transform(f(i,:,k));//input data is array of length ny, output with
same length replace initial one
}

Thus, applying the asynchronous approach to a direct Poisson solver for clusters enables the reduction of idle processes when the number of processes is relatively large. Data transfer can be done concurrently with the calculation of a previous step. Consequently, the process downtime will be considerably reduced and the performance of, for example, a Poisson solver package on computers with distributed memory can be increased. This may aid those who use, for example, Poisson solvers for clusters with weather forecasting, oil pollution simulation, and the like.

As used herein, “concurrently” may entail first and second processes starting at the same time and ending at the same time, starting at the same time and ending at different times, starting at different times and ending at the same time, or starting at different times and ending at different times but overlapping to some extent.

An embodiment includes a method executed by at least one processor comprising: performing a first mathematical transform on a first subarray of an array of data via a first computer process executing on a first computer node of a distributed computer cluster concurrently with a second mathematical transform being performed on a second subarray of the array via a second computer process executing on a second computer node of the computer cluster; after the first and second subarrays are transformed into transformed first and second subarrays, performing a third mathematical transform on a third subarray of the array via the first computer node concurrently with: (a) a fourth mathematical transform being performed on a fourth subarray of the array via the second computer node; and (b) both the transformed first and second subarrays being transposed to transposed first and second subarrays located on one node of the first and second computer nodes and a third computer node included in the computer cluster via a communication path coupling at least two of the first, second, and third computer nodes; wherein the first subarray is stored in a first memory of the first computer node, and the second subarray is stored in a second memory of the second computer node. An embodiment includes beginning performing the third mathematical transform and transposing the transformed first subarray at a first single moment of time and ending performing the third mathematical transform and transposing the transformed first subarray at a second single moment of time; wherein the transform is one of an Abel, Bateman, Bracewell, Fourier, Short-time Fourier, Hankel, Hartley, Hilbert, Hilbert-Schmidt integral operator, Laplace, Inverse Laplace, Two-sided Laplace, Inverse two-sided Laplace, Laplace-Carson, Laplace-Stieltjes, Linear canonical, Mellin, Inverse Mellin, Poisson-Mellin-Newton cycle, Radon, Stieltjes, Sumudu, Wavelet, discrete, binomial, discrete Fourier transform, Fast Fourier transform, discrete cosine, modified discrete cosine, discrete Hartley, discrete sine, discrete wavelet transform, fast wavelet, Hankel transform, irrational base discrete weighted, number-theoretic, Stirling, discrete-time, discrete-time Fourier transform, Z, Karhunen-Loève, Bäcklund, Bilinear, Box-Muller, Burrows-Wheeler, Chirplet, distance, fractal, Hadamard, Hough, Legendre, Möbius, perspective, and Y-delta transform; wherein the communication path includes one of a wired path, a wireless path, and a cellular path. An embodiment includes, after the third and fourth subarrays are transformed into transformed third and fourth subarrays, transposing both the transformed third and fourth subarrays to transposed third and fourth subarrays located on an additional node of the first, second, and third computer nodes. An embodiment includes decomposing the first and second transposed subarrays into decomposed first and second subarrays via the one node while the third and fourth transposed subarrays are decomposed into decomposed third and fourth subarrays via the additional node. An embodiment includes transposing both the decomposed first and third subarrays to transposed first and third subarrays located on the one node while a fifth subarray is decomposed. An embodiment includes transposing both the decomposed first and third subarrays to transposed first and third subarrays located on another of the first, second, and third computer nodes while a fifth subarray is decomposed. In an embodiment decomposing the first transposed subarray includes decomposing the first transposed subarray via LU decomposition. In an embodiment the first subarray is stored at a first memory address of the first memory and the transformed first subarray is stored at the first memory address. An embodiment includes, after the third and fourth subarrays are transformed into transformed third and fourth subarrays, transposing both the transformed third and fourth subarrays to transposed third and fourth subarrays located on the one node. An embodiment includes concurrently decomposing the third and fourth transposed subarrays into decomposed third and fourth subarrays and then transposing the decomposed third and fourth subarrays to different nodes of the computer cluster. In an embodiment the array of data is included in a matrix and the method further comprises, based on the transposed first and second subarrays, modeling at least one of electromagetics, electrodynamics, sound, fluid dynamics, weather, and thermal transfer.

An embodiment includes a processor based system comprising: at least one memory to store a first subarray of an array of data that also includes second, third, and fourth subarrays; and at least one processor, coupled to the at least one memory, to perform operations comprising: performing a first mathematical transform on the first subarray via a first computer process executing on a first computer node of a distributed computer cluster concurrently with a second mathematical transform being performed on the second subarray via a second computer process executing on a second computer node of the computer cluster; and after the first and second subarrays are transformed into transformed first and second subarrays, performing a third mathematical transform on the third subarray via the first computer node concurrently with both the transformed first and second subarrays being transposed to transposed first and second subarrays located on one node of the first and second computer nodes and a third computer node included in the computer cluster via a communication path coupling at least two of the first, second, and third computer nodes; wherein the first computer node includes the at least one memory. An embodiment includes after the third subarray and the fourth subarray are transformed into transformed third and fourth subarrays, transposing both the transformed third and fourth subarrays to transposed third and fourth subarrays located on an additional node of the first, second, and third computer nodes. An embodiment includes decomposing the first and second transposed subarrays into decomposed first and second subarrays via the one node while the third and fourth transposed subarrays are decomposed into decomposed third and fourth subarrays via the additional node. An embodiment includes transposing both the decomposed first and third subarrays to transposed first and third subarrays located on the one node while a fifth subarray is decomposed. An embodiment includes transposing both the decomposed first and third subarrays to transposed first and third subarrays located on another of the first, second, and third computer nodes while a fifth subarray is decomposed. An embodiment includes the first, second, and third computer nodes.

An embodiment includes a processor based system comprising: a first computer node, included in a distributed computer cluster and comprising at least one memory coupled to at least one processor, to perform operations comprising: the first computer node concurrently (a) calculating one or more mathematical transforms on data stored in the at least one memory while (b) transposing one or more transformed arrays of data. An embodiment includes the first computer node concurrently (a) calculating one or more mathematical transforms on data stored in the at least one memory while (b) transposing one or more transformed arrays of data to a second computer node included in the distributed computer cluster. An embodiment includes the first computer node concurrently (a) calculating one or more mathematical transforms on data stored in the at least one memory while (b) transposing one or more transformed arrays of data from a second computer node included in the distributed computer cluster. An embodiment includes the first computer node decomposing the transposed one or more transformed arrays of data while one or more additional arrays are transposed. An embodiment includes the first computer node decomposing the transposed one or more transformed arrays of data while transposing one or more additional arrays.

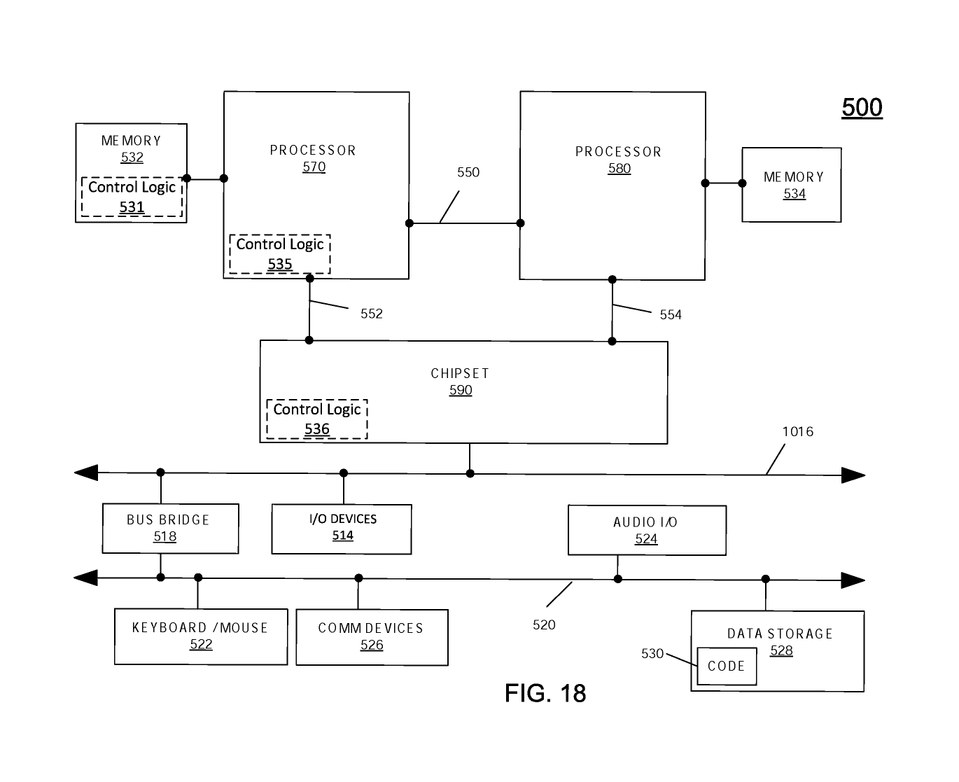

Embodiments may be implemented in many different system types. Referring now to FIG. 18, shown is a block diagram of a system in accordance with an embodiment of the present invention. System 500 may suffice for a compute or computing node that operates any process in the above examples (e.g., Node 1 of FIG. 12a). Multiprocessor system 500 is a point-to-point interconnect system, and includes a first processor 570 and a second processor 580 coupled via a point-to-point interconnect 550. Each of processors 570 and 580 may be multicore processors. The term “processor” may refer to any device or portion of a device that processes electronic data from registers and/or memory to transform that electronic data into other electronic data that may be stored in registers and/or memory. First processor 570 may include a memory controller hub (MCH) and point-to-point (P-P) interfaces. Similarly, second processor 580 may include a MCH and P-P interfaces. The MCHs may couple the processors to respective memories, namely memory 532 and memory 534, which may be portions of main memory (e.g., a dynamic random access memory (DRAM)) locally attached to the respective processors. First processor 570 and second processor 580 may be coupled to a chipset 590 via P-P interconnects, respectively. Chipset 590 may include P-P interfaces. Furthermore, chipset 590 may be coupled to a first bus 516 via an interface. Various input/output (I/O) devices 514 may be coupled to first bus 516, along with a bus bridge 518, which couples first bus 516 to a second bus 520. Various devices may be coupled to second bus 520 including, for example, a keyboard/mouse 522, communication devices 526, and data storage unit 528 such as a disk drive or other mass storage device, which may include code 530, in one embodiment. Code may be included in one or more memories including memory 528, 532, 534, memory coupled to system 500 via a network, and the like. Further, an audio I/O 524 may be coupled to second bus 520.

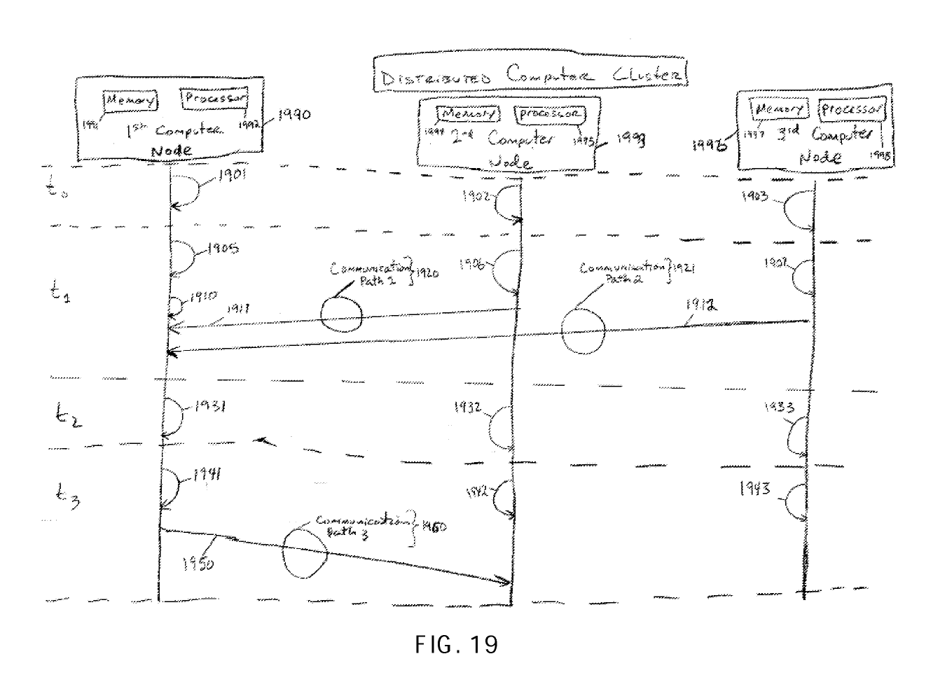

FIG. 19 includes a distributed computer cluster in one embodiment of the invention. The cluster can be used to implement various processes or methods described herein. For example, one method includes performing a mathematical transform 1901 on a subarray of data (stored in memory 1991) via a computer process executing (via processor 1992) on a computer node 1990 of a distributed computer cluster concurrently (overlapping to some extent during time t₀) with a mathematical transform 1902 being performed on a subarray (stored in memory 1994) via a computer process executing (via processor 1995) on a computer node 1993 of the computer cluster. This may also occur concurrently (overlapping to some extent during time t₀) with mathematical transform 1903 being performed on another subarray (stored in memory 1997) via a computer process executing (via processor 1998) on a computer node 1996 of the computer cluster.

After subarrays are transformed the process may include performing a mathematical transform 1905 on a subarray (stored in memory 1991 or elsewhere) via computer node 1900 concurrently (overlapping to some extent during time t₁) with: (a) mathematical transform 1906 being performed on a subarray (stored in memory 1994 or elsewhere) via computer node 1993 (and/or transform 1907 being performed on a subarray stored in memory 1997 or elsewhere via computer node 1996); and (b) transformed subarray(s) being transposed (e.g., transpose actions 1910, 1911, and/or 1912) to transposed subarrays located on “one node” of the first, second, third computer nodes 1990, 1993, 1998 (or another node) via a communication path (e.g., paths 1920, 1921 and the like) coupling at least two of the nodes. In the example of FIG. 19, transformed data is transposed on paths 1920, 1921 via transposition actions 1910, 1911, and/or 1912. These are just examples and other embodiments are not so limited. Thus, the “one node” mentioned immediately above may not be node 1990, but may instead be node 1993, 1996 or another node entirely.

One embodiment may include decomposing 1931 transposed subarrays into decomposed subarrays via node 1990 while (overlapping to some extent during time t₂) other transposed subarrays are decomposed (e.g., 1932, 1933) via additional nodes (e.g., 1993, 1996). One embodiment may include transposing (action 1950 conducted via path 1960) a decomposed subarray to a transposed subarray located on node 1993 while (overlapping to some extent during time t₃) other subarrays are decomposed 1941, 1942, 1943. Other embodiments may include transposing a decomposed subarray to a transposed subarray located on node 1990, 1996 and/or another node entirely.

Embodiments may be implemented in code and may be stored on storage medium having stored thereon instructions which can be used to program a system to perform the instructions. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

Embodiments of the invention may be described herein with reference to data such as instructions, functions, procedures, data structures, application programs, configuration settings, code, and the like. When the data is accessed by a machine, the machine may respond by performing tasks, defining abstract data types, establishing low-level hardware contexts, and/or performing other operations, as described in greater detail herein. The data may be stored in volatile and/or non-volatile data storage. The terms “code” or “program” cover a broad range of components and constructs, including applications, drivers, processes, routines, methods, modules, and subprograms and may refer to any collection of instructions which, when executed by a processing system, performs a desired operation or operations. In addition, alternative embodiments may include processes that use fewer than all of the disclosed operations, processes that use additional operations, processes that use the same operations in a different sequence, and processes in which the individual operations disclosed herein are combined, subdivided, or otherwise altered. In one embodiment, use of the term control logic includes hardware, such as transistors, registers, or other hardware, such as programmable logic devices (535). However, in another embodiment, logic also includes software or code (531). Such logic may be integrated with hardware, such as firmware or micro-code (536). A processor or controller may include control logic intended to represent any of a wide variety of control logic known in the art and, as such, may well be implemented as a microprocessor, a micro-controller, a field-programmable gate array (FPGA), application specific integrated circuit (ASIC), programmable logic device (PLD) and the like.

Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. At least one storage medium having instructions stored thereon for causing a system to perform a method comprising:
performing a first mathematical transform on a first subarray of an array of data via a first computer process executing on a first computer node of a distributed computer cluster concurrently with a second mathematical transform being performed on a second subarray of the array via a second computer process executing on a second computer node of the computer cluster;
after the first and second subarrays are transformed into transformed first and second subarrays, performing a third mathematical transform on a third subarray of the array via the first computer node concurrently with:
(a) a fourth mathematical transform being performed on a fourth subarray of the array via the second computer node; and
(b) both the transformed first and second subarrays being transposed to transposed first and second subarrays located on one node of the first and second computer nodes and a third computer node included in the computer cluster via a communication path coupling at least two of the first, second, and third computer nodes;
wherein the first subarray is stored in a first memory of the first computer node, and the second subarray is stored in a second memory of the second computer node.

2. The at least one medium of claim 1 the method further comprising:
beginning performing the third mathematical transform and transposing the transformed first subarray at a first single moment of time and ending performing the third mathematical transform and transposing the transformed first subarray at a second single moment of time;
wherein the transform is one of an Abel, Bateman, Bracewell, Fourier, Short-time Fourier, Hankel, Hartley, Hilbert, Hilbert-Schmidt integral operator, Laplace, Inverse Laplace, Two-sided Laplace, Inverse two-sided Laplace, Laplace-Carson, Laplace-Stieltjes, Linear canonical, Mellin, Inverse Mellin, Poisson-Mellin-Newton cycle, Radon, Stieltjes, Sumudu, Wavelet, discrete, binomial, discrete Fourier transform, Fast Fourier transform, discrete cosine, modified discrete cosine, discrete Hartley, discrete sine, discrete wavelet transform, fast wavelet, Hankel transform, irrational base discrete weighted, number-theoretic, Stirling, discrete-time, discrete-time Fourier transform, Z, Karhunen-Loève, Bäcklund, Bilinear, Box-Muller, Burrows-Wheeler, Chirplet, distance, fractal, Hadamard, Hough, Legendre, Möbius, perspective, and Y-delta transform;
wherein the communication path includes one of a wired path, a wireless path, and a cellular path.

3. The at least one medium of claim 1, the method comprising, after the third and fourth subarrays are transformed into transformed third and fourth subarrays, transposing both the transformed third and fourth subarrays to transposed third and fourth subarrays located on an additional node of the first, second, and third computer nodes.

4. The at least one medium of claim 3, the method comprising decomposing the first and second transposed subarrays into decomposed first and second subarrays via the one node while the third and fourth transposed subarrays are decomposed into decomposed third and fourth subarrays via the additional node.

5. The at least one medium of claim 4, the method comprising transposing both the decomposed first and third subarrays to transposed first and third subarrays located on the one node while a fifth subarray is decomposed.

6. The at least one medium of claim 4, the method comprising transposing both the decomposed first and third subarrays to transposed first and third subarrays located on another of the first, second, and third computer nodes while a fifth subarray is decomposed.

7. The at least one medium of 4, wherein decomposing the first transposed subarray includes decomposing the first transposed subarray via LU decomposition.

8. The at least one medium of claim 1, wherein the first subarray is stored at a first memory address of the first memory and the transformed first subarray is stored at the first memory address.

9. The at least one medium of claim 1 comprising, after the third and fourth subarrays are transformed into transformed third and fourth subarrays, transposing both the transformed third and fourth subarrays to transposed third and fourth subarrays located on the one node.

10. The at least one medium of claim 9, the method comprising concurrently decomposing the third and fourth transposed subarrays into decomposed third and fourth subarrays and then transposing the decomposed third and fourth subarrays to different nodes of the computer cluster.

11. The at least one medium of claim 1, wherein the array of data is included in a matrix and the method further comprises, based on the transposed first and second subarrays, modeling at least one of electromagnetics, electrodynamics, sound, fluid dynamics, weather, and thermal transfer.

12. (canceled)

13. (canceled)

14. A processor based system comprising:
at least one memory to store a first subarray of an array of data that also includes second, third, and fourth subarrays; and
at least one processor, coupled to the at least one memory, to perform operations comprising:
performing a first mathematical transform on the first subarray via a first computer process executing on a first computer node of a distributed computer cluster concurrently with a second mathematical transform being performed on the second subarray via a second computer process executing on a second computer node of the computer cluster; and
after the first and second subarrays are transformed into transformed first and second subarrays, performing a third mathematical transform on the third subarray via the first computer node concurrently with both the transformed first and second subarrays being transposed to transposed first and second subarrays located on one node of the first and second computer nodes and a third computer node included in the computer cluster via a communication path coupling at least two of the first, second, and third computer nodes;
wherein the first computer node includes the at least one memory.

15. The system of claim 14, wherein the operations comprise, after the third subarray and the fourth subarray are transformed into transformed third and fourth subarrays, transposing both the transformed third and fourth subarrays to transposed third and fourth subarrays located on an additional node of the first, second, and third computer nodes.

16. The system of claim 15, wherein the operations comprise decomposing the first and second transposed subarrays into decomposed first and second subarrays via the one node while the third and fourth transposed subarrays are decomposed into decomposed third and fourth subarrays via the additional node.

17. The system of claim 16, wherein the operations comprise transposing both the decomposed first and third subarrays to transposed first and third subarrays located on the one node while a fifth subarray is decomposed.

18. The system of claim 16, wherein the operations comprise transposing both the decomposed first and third subarrays to transposed first and third subarrays located on another of the first, second, and third computer nodes while a fifth subarray is decomposed.

19. The system of claim 15 comprising the first, second, and third computer nodes.

20. A processor based system comprising:
a first computer node, included in a distributed computer cluster and comprising at least one memory coupled to at least one processor, to perform operations comprising:
the first computer node concurrently (a) calculating one or more mathematical transforms on data stored in the at least one memory while (b) transposing one or more transformed arrays of data.

21. The system of claim 20, wherein the operations comprise the first computer node concurrently (a) calculating one or more mathematical transforms on data stored in the at least one memory while (b) transposing one or more transformed arrays of data to a second computer node included in the distributed computer cluster.

22. The system of claim 20, wherein the operations comprise the first computer node concurrently (a) calculating one or more mathematical transforms on data stored in the at least one memory while (b) transposing one or more transformed arrays of data from a second computer node included in the distributed computer cluster.

23. The system of claim 20 wherein the operations comprise the first computer node decomposing the transposed one or more transformed arrays of data while one or more additional arrays are transposed.

24. The system of claim 20 wherein the operations comprise the first computer node decomposing the transposed one or more transformed arrays of data while transposing one or more additional arrays.
